(19) United States
(12) Patent Application Publication
(10) Pub. No.: US 2014/0136686 A1
(43) Pub. Date: May 15, 2014

(54) DYNAMIC RESOLUTION REGULATING SYSTEM AND DYNAMIC RESOLUTION REGULATING METHOD

(71) Applicant: INSTITUTE FOR INFORMATION INDUSTRY, Taipei (TW)

(72) Inventors: Yu-Chin TSAI, New Taipei City (TW); Hui-Kuang CHUNG, Taipei City (TW); Ching-Ju LIN, Taipei City (TW)

(73) Assignee: INSTITUTE FOR INFORMATION INDUSTRY, Taipei (TW)

(21) Appl. No.: 13/707,612

(22) Filed: Dec. 7, 2012

(30) Foreign Application Priority Data
Nov. 9, 2012 (TW) 101141826

(51) Int. Cl. H04L 12/26

(52) U.S. Cl. CPC H04L 43/0876
USPC 709/224

(57) ABSTRACT

Disclosed herein is a dynamic resolution regulating system for uses in a server that is connected to a client device via a network. The dynamic resolution regulating system includes a network monitoring unit and an image-processing unit. The network-monitoring unit is operable to monitor and analyze network transmission quality for the server and client device, and the image-processing unit is operable to adjust the resolutions of a region-of-interest (ROI) and a region-of-non-interest (non-ROI) in an image based on the network transmission quality, such that the client device can receive the image via the network. Also disclosed herein is a method for dynamic solution regulating method.

### RELATED APPLICATIONS

This application claims priority to Taiwan Application Serial Number 101141826, filed Nov. 9, 2012, which is herein incorporated by reference.

### BACKGROUND

1. Technical Field

The present disclosure relates to remote desktop technologies, and more particularly, a remote desktop technology with better user experience when network quality is poor.

2. Description of Related Art

Cloud computing is a network (such as the Internet)-based computation by which the shared hardware and/or software resources are delivered to computers and other devices as needed.

Cloud computing is a drastic revolution, just like the transition from mainframe computers to client-server in 1980's. Users are no longer required to understand the details of the infrastructure in the “cloud,” nor should they possess corresponding professional knowledge associated with the cloud. Also, it is not necessary for them to directly control the cloud. Cloud computing provides novel, internet-based IT service, usage and payment models, which usually involve providing dynamic, expendable functions that are often virtualized resources. Typical cloud computing provides generally provide common internet service application, such that the user may access the software and data stored on the server through applications (e.g., browsers) or other Web services.

Currently, when the remote desktop service suffers from network congestion, it would discard a portion of images due to the insufficiency of the available network bandwidth. Hence, it is unable to display images smoothly. Decreasing the overall image resolution could save the need for the bandwidth, yet the quality of the image to be played is substantially decreased.

U.S. Pat. No. 7,895,521 disclose a remote desktop service in which the user has to set parameters associated with the region-of-interest (ROI) but the visibility is not real-time. Further, a remote desktop GUI (graphical user interface) should be established to facilitate manual management, and the GUI needs to be re-adjusted whenever an area is opened. Also, U.S. Pat. No. 7,895,521 does not specifically teach or design a mechanism with respect to the management of network usage (e.g., issues associated with network congestion).

In view of the foregoing, there exist problems and disadvantages in the current technologies that await further improvement. However, those skilled in the art sought vainly for a solution. In order to solve or circumvent above problems and disadvantages, there is an urgent need in the related field to achieve the optimization of image quality as well as improve the smoothness of image display.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to a dynamic resolution regulating system and d a dynamic resolution regulating method for dynamically setting differential resolutions for sub-regions and appropriately adjusting these resolutions according the importance or priority of the sub-regions, so as to achieve the optimization of image quality as well as improve the smoothness of image display.

According to one embodiment of the present invention, a dynamic resolution regulating system for uses in a server that is connected to a client device via a network, and the dynamic resolution regulating system includes a network-monitoring unit and an image-processing unit. The network-monitoring unit monitors and analyzes network transmission quality for the server and the client device. The image-processing unit adjusts resolutions of a region-of-interest (ROI) and a region-of-non-interest (non-ROI) in an image based on the network transmission quality, such that the client device receives the image via the network.

The image-processing unit includes a ROI detection module, a resolution-adjusting module and a image compression module. The ROI detection module automatically recognizes the region-of-interest in the image and determining the other portion in the image as the region-of-non-interest. The resolution-adjusting module reduces the resolution of the region-of-non-interest and retaining the resolution of the region-of-interest when the network is congested. The image compression module compresses the image according to the resolutions of the region-of-interest and the region-of-non-interest.

The network-monitoring unit includes a bandwidth measurement module and a Quality of Service (QoS) estimation module. The bandwidth to measurement module measures a bandwidth usage. The QoS estimation module estimates the network transmission quality.

The content of the image is a text, a picture or a video content.

The client device is a thin client device.

According to another embodiment of the present invention, a dynamic resolution regulating method for uses in a server that is connected to a client device via a network, and the dynamic resolution regulating method includes steps of (a) monitoring and analyzing network transmission quality for the server and the client device, and (b) adjusting resolutions of a region-of-interest (ROI) and a region-of-non-interest (non-ROI) in an image based on the network transmission quality, such that the client device receives the image via the network.

In the step (b), the region-of-interest is automatically recognized in the image, and the other portion in the image is determined as the region-of-non-interest; the resolution of the region-of-non-interest is reduced, and the resolution of the region-of-interest is retained when the network is congested; and, the image is compressed according to the resolutions of the region-of-interest and the region-of-non-interest.

In the step (a), a bandwidth usage is measured, and the network transmission quality is estimated.

In above dynamic resolution regulating method, content of the image is a text, a picture or a video content.

The client device is a thin client device.

Technical advantages are generally achieved, by embodiments of the present invention, as follows:

1. The network congestion situation can be detected immediately and automatically;

2. A sub-region (e.g., region of interest) can he discriminated from the other region, and the cost of management is reduced; and

3. The resolutions can be dynamically adjusted in response to real-time network conditions.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of a dynamic resolution regulating system according to one embodiment of the present disclosure; and

FIG. 2 is a flow diagram of a dynamic resolution regulating method according to one embodiment of the present disclosure.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to he understood to be open-ended, i.e., to mean including but not limited to. As used in the description herein and throughout the claims that follow, the meaning of “in” includes “in” and “on” unless the context clearly dictates otherwise.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, ell terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

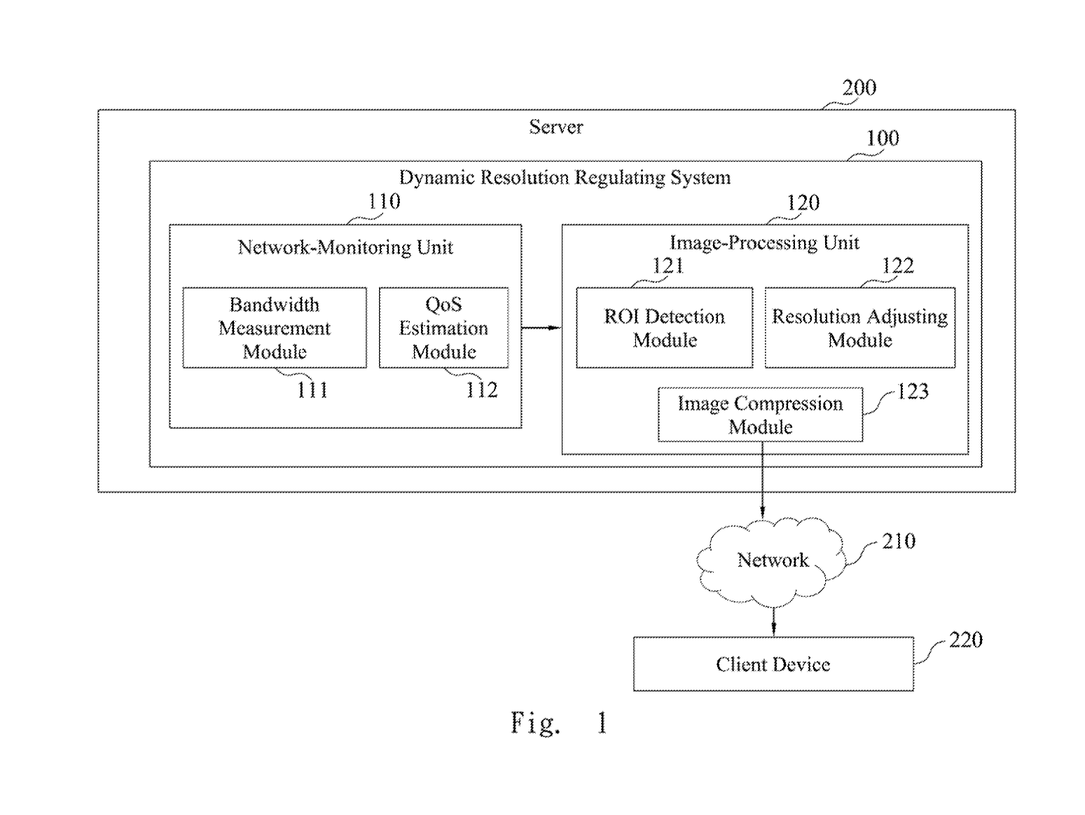

In one aspect, the present disclosure is directed to a dynamic resolution regulating system. This system may be used in the server (e.g., a remote desktop server), or may be widely used in other relevant technical fields. The specific embodiments exemplifying the system are described below in conjunction with FIG. 1.

FIG. 1 is a block diagram of a dynamic resolution regulating system 100 according to one embodiment of the present disclosure. As illustrated in FIG. 1, the dynamic resolution regulating system 100 for uses in a server 200, and the server 200 is connected to a client device 220 via a network 210.

The dynamic resolution regulating system 100 includes a network-monitoring unit 110 and an image-processing unit 120. The network-monitoring unit 110 is coupled with the image-processing unit 120. In use, the network-monitoring unit 110 monitors and analyzes network transmission quality for the server 200 and the client device 220. The image-processing unit 120 adjusts resolutions of a region-of-interest (ROI) and a region-of-non-interest (non-ROI) in an image based on the network transmission quality, such that the client device 220 can receive the image via the network 210, so as to improve visual experience and satisfaction with ROI. Thus, the present system can dynamically set differential resolution for sub-regions (Le. ROI) and appropriately adjusting these resolutions according the importance or priority of the sub-regions, so as to achieve the optimization of image quality as well as improve the smoothness of image display.

Specifically, the image-processing unit 120 includes a ROI detection module 121, a resolution-adjusting module 122 and a image compression module 123. The ROI detection module 121 is based on a conventional or future-developed ROI detection technology to automatically recognize the region-of-interest in the image (e.g., sensing AP format for classification) and determine the other portion in the image as the region-of-non-interest. When the network is congested, the resolution-adjusting module reduces the resolution of the region-of-non-interest and retaining the resolution of the region-of-interest, so as to avoid excessive loss of frames for affecting the smoothness of image display. The image compression module 123 compresses the image according to the resolutions of the region-of-interest and the region-of-non-interest. Thus, the system can do adjustment according to the network bandwidth, to minimize the amount of data loss. It should be noted that the system can learn user interests through the server 200 and automatically adjust compression strategy, without manually specify the area of interest by a client. Therefore, the existing client device is compatible with the system without re-installing the new program.

The present invention is adapted to thin clients. In one embodiment, the client device 220 could be a thin client device such as a mobile device (e.g., cell phone, tablet PC, etc.). Since most mobile devices are not equipped with the large display of personal computers, the present technology provides the user a better visual perception of the region of interest.

Moreover, The network-monitoring unit 110 includes a bandwidth measurement module 111 and a Quality of Service (QoS) estimation module 112. The bandwidth measurement module 111 measures a bandwidth usage. The QoS estimation module 112 estimates the transmission quality of the network 210 (i.e., the network transmission quality). Then, the image-processing unit 120 adjusts resolutions of a region-of-interest (ROI) and a region-of-non-interest (non-ROI) based on the bandwidth usage and the network transmission quality. Thus, the present system for dynamic detection of bandwidth could be used in the field of image resolving. Hence, the present system is capable of ameliorating the non-smoothness of frames caused by low Internet speed due to the ever-increasing user demand.

The ROI detection mechanism is introduced into the present invention from the image-processing field, and automatically divides the image into the regions of interest and the regions-of-non-interest area, without a manual adjustment. In one embodiment, the content of the image may be text. In a desktop system, the text content is displayed as a picture, in which text blocks are set to be important regions. The resolution of the non-text portion is reduced or the non-text portion is omitted according to the boundary between the text blocks and non-text portion.

Alternatively or additionally, in another embodiment, the content of the image may be a video content. In the desktop system, the dynamic play area is recognized as the ROI, in which dynamic image portions maintain high resolution. The resolution of static image portions can be reduced, or the static image portions are omitted according o the boundary between the dynamic and static image portions.

Alternatively or additionally, in yet another embodiment, the content of the image may be a picture. In the desktop system, the ROI detection tool and an application for displaying the picture are linked together. Before the complete image is transmitted from the server to the client, the ROI detection tool can select an area as the region-of-interest, and reduce the resolution of the other region, so as to enhance the image quality of the selected area.

The network-monitoring unit 110 and the image-processing unit 120 may be hardware, software, and/or firmware. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

In practice, the present method is embodied in software that could be integrated into existing cloud computing system easily, and is not limited to different platforms of operating systems. For frequent users of mobile devices, the present method provides better visual perceptions in addition to the basic functions like the connection to the cloud platform. In the situations where the available bandwidth is limited or in peak periods where user demands are extremely high, users would not experience the downgrade of the image quality. In addition, the present method allows the user to choose whether the client-end module is to be used, thereby it is compatible with existing client-end platform that facilitate the expansion of the adaptability of use.

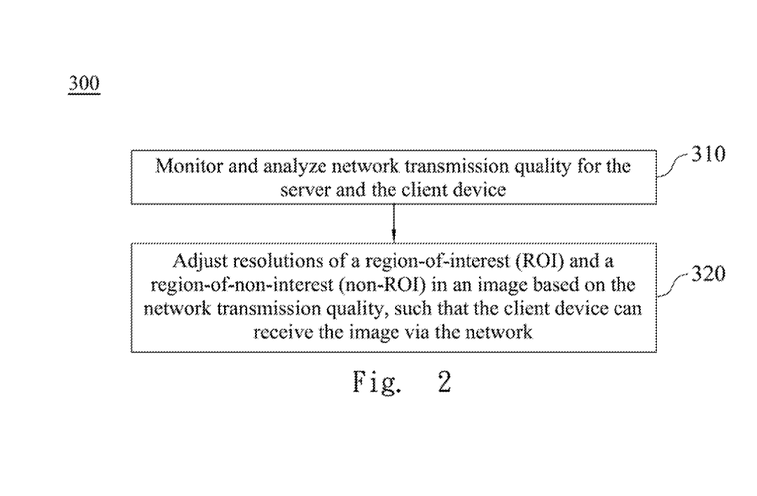

FIG. 2 is a flow diagram of a dynamic resolution regulating method 300 according to one embodiment of the present disclosure. The dynamic resolution regulating method 300 can be used in aforesaid server 200. The dynamic resolution regulating method 300 includes steps 310-320 as follows (The steps are not recited in the sequence in which the steps are performed. That is, unless the sequence of the steps is expressly indicated, the sequence of the steps is interchangeable, and all or part of the steps may be simultaneously, partially simultaneously, or sequentially performed). It should be noted that those implements to perform the steps in the method 300 are disclosed in above embodiments and, thus, are not repeated herein.

First, the step 310 is to monitor and analyze network transmission quality for the server and the client device. The step 320 is to adjust resolutions of a region-of-interest (ROI) and a region-of-non-interest (non-ROI) in an image based on the network transmission quality, such that the client device can receive the image via the network, so as to improve visual experience and satisfaction with ROI. Thus, the present system can dynamically set differential resolution for sub-regions (i.e., ROI) and appropriately adjusting these resolutions according the importance or priority of the sub-regions, so as to achieve the optimization of image quality as well as improve the smoothness of image display.

Specifically, in step 320, the region-of-interest is automatically recognized in the image, and the other portion in the image is determined as the region-of-non-interest; when the network is congested, the resolution of the region-of-non-interest is reduced, and the resolution of the region-of-interest is retained, so as to avoid excessive loss of frames for affecting the smoothness of image display; and, the image is compressed according to the resolutions of the region-of-interest and the region-of-non-interest. Thus, the present method can do adjustment according to the network bandwidth, to minimize the amount of data loss. It should be noted that the present method can learn user interests through the server and automatically adjust compression strategy, without manually specify the area of interest by a client. Therefore, the existing client device is compatible with the system without re-installing the new program.

Moreover, in the step 310, a bandwidth usage is measured, and the transmission quality of the network (i.e., the network transmission quality) is estimated. Then, the step 320 is to adjust resolutions of a region-of-interest (ROI) and a region-of-non-interest (non-ROI) based on the bandwidth usage and the network transmission quality. Thus, the present method for dynamic detection of bandwidth could be used in the field of image resolving. Hence, the present method is capable of ameliorating the non-smoothness of frames caused by low Internet speed due to the ever-increasing user demand.

In the dynamic resolution regulating method 300, the content of the image is a text, a picture, a video content or the combinations thereof. In practice, the present method recognizes content in an application as various objects, i.e., the text, the picture, the video content, or the like, and further analyzes the region-of-interest (ROI) for appropriately adjusting the resolution of the region-of-interest.

Moreover, the client device could be a thin client device such as a mobile device (e.g., cell phone, tablet PC, etc.). Since most mobile devices are not equipped with the large display of personal computers, the present method provides the user a better visual perception of the region of interest.

The dynamic resolution regulating method 300 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs: and magnetic storage devices such as hard disk drives and floppy disk drives.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A dynamic resolution regulating system for uses in a server that is connected to a client device via a network, the dynamic resolution regulating system comprising:
a network-monitoring unit for monitoring and analyzing network transmission quality for the server and the client device; and
an image-processing unit for adjusting resolutions of a region-of-interest (ROI) and a region-of-non-interest (non-ROI) in an image based on the network transmission quality, such that the client device receives the image via the network.

2. The dynamic resolution regulating system of claim 1, wherein the image-processing unit comprises:
a ROI detection module for automatically recognizing the region-of-interest in the image and determining the other portion in the image as the region-of-non-interest;
a resolution-adjusting module for reducing the resolution of the region-of-non-interest and retaining the resolution of the region-of-interest when the network is congested; and
an image compression module for compressing the image according to the resolutions of the region-of-interest and the region-of-non-interest.

3. The dynamic resolution regulating system of claim 1, wherein the network-monitoring unit comprises:
a bandwidth measurement module for measuring a bandwidth usage; and
a Quality of Service (QoS) estimation module for estimating the network transmission quality.

4. The dynamic resolution regulating system of claim 1, wherein content of the image is a text, a picture or a video content.

5. The dynamic resolution regulating system of claim 1, wherein the client device is a thin client device.

6. A dynamic resolution regulating method for uses in a server that is connected to a client device via a network, the dynamic resolution regulating method comprising:
(a) monitoring and analyzing network transmission quality for the server and the client device; and
(b) adjusting resolutions of a region-of-interest (ROI) and a region-of-non-interest (non-ROI) in an image based on the network transmission quality, such that the client device receives the image via the network.

7. The dynamic resolution regulating method of claim 6, wherein the step (b) comprises:
automatically recognizing the region-of-interest in the image and determining the other portion in the image as the region-of-non-interest;
reducing the resolution of the region-of-non-interest and retaining the resolution of the region-of-interest when the network is congested; and
compressing the image according to the resolutions of the region-of-interest and the region-of-non-interest.

8. The dynamic resolution regulating method of claim 6, wherein the step (a) comprises:
measuring a bandwidth usage; and
estimating network transmission quality.

9. The dynamic resolution regulating method of claim 6, wherein content of the image is a text, a picture or a video content.

10. The dynamic resolution regulating method of claim 6, wherein the client device is a thin client device.
